(19) United States
(12) Patent Application Publication
(10) Pub. No.: US 2003/0160355 A1
(43) Pub. Date: Aug. 28, 2003

(54) Method for making three or four-layer golf ball

(76) Inventor: Fu-Cheng Cheng, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,079

(22) Filed: Feb. 26, 2002

(51) Int. Cl. B29C 35/00

(52) U.S. Cl. 264/138; 264/326

(57) ABSTRACT

The present invention relates to a method for making three or four-layer golf ball, characterized in which after the materials for the rubber composition of the golf ball core are blended in set proportions and vulcanized, said vulcanized blend is placed in a compression mould under 180° C. temperature for about 120 seconds to form an integral core having a concentric construction of two or three layers with increasing hardness from inside out. Furthermore, the rigid surface of the core is subjected to centerless grinding and then coated with a cover layer of thermoplastic resin by injection molding to form a complete golf ball. Such method is simple, convenient, time-saving, efficient and economical. The golf ball core produced thereof possesses a rigid surface that is not prone to deformation and is integrated uniformly and securely with the cover layer, resulting in higher yield. Moreover with the softer inner layer of the core and the uniform dispersion of layer structures, the ball gives the golfers better feel, greater precision control and stability where the ball is not prone to deflection when hit.

### BACKGROUND OF THE INVENTION

1. Field of the Invention

The invention herein relates to a method for making three or four-layer golf ball, particularly a method in which after the materials for the rubber composition of the golf ball core are blended in set proportions and vulcanized, said blend is placed in a compression mould under 180° C. for about 120 seconds to form an integral core having a concentric construction of two or three layers with increasing hardness from inside out. Furthermore, the rigid surface of the core is subjected to centerless grinding and then coated with a cover layer of thermoplastic resin by injection molding to form a complete golf ball. Such method is simple, convenient, time-saving, efficient and economical. The golf ball core produced thereof possesses a rigid surface that is not prone to deformation and is integrated uniformly and firmly with the cover layer, resulting in higher yield. Moreover with the softer inner layer of the core and the uniform dispersion of layer structures, the ball offers better feel, greater precision control and enhanced flight performance.

2. Description of the Related Art

The conventional construction of a golf ball comes in single layer, double layers, three layers or four layers. Single layer golf ball is formed in one body which has identical compositions and hardness throughout; double-layer golf ball comprises a solid core and a separable cover where the core and the cover have different hardness and ingredients; three-layer golf ball usually consists of a solid or liquid-filled core wound with a layer of rubber threads or solid rubber shell and then coated with an outer cover and each layer has different hardness and materials; four-layer golf ball has a construction similar to that of the three-layer ball, only it has an additional layer of wound rubber threads or solid rubber shell inside the outer cover. These golf balls of different constructions produce varying effects in application. But to achieve certain effects, such as giving the golfer better feel, having better shot distance, superior durability or greater stability after the strike, three or four-layer golf balls are used more extensively at the present time.

The common methods and steps for making three or four-layer golf balls at the present time are:

Three-layer ball:

1. Blending the various materials for rubber composition in set proportions (approximately 68% polybutadien rubber, 9% ZnO, 21% zinc diacrylate (ZDA), 1.8% TiO2, and 0.2% peroxide) and vulcanizing the blend to form golf ball core;

2. subjecting the core to grinding to obtain the desired dimensions and roundness;

3. forming an intermediate layer around the core by winding the customarily employed rubber thread or by injection molding using thermoplastic elastomer (TPE); and

4. forming a cover layer of Surlyn around the intermediate layer by injection molding.

Four-layer ball:

1. Blending the various materials for rubber composition in set proportions (approximately 68% polybutadien rubber, 9% ZnO, 21% zinc diacrylate (ZDA), 1.8% TiO2, and 0.2% peroxide) and vulcanizing the blend to form golf ball core;

2. subjecting the core to grinding to obtain the desired dimensions and roundness;

3. forming a first intermediate layer around the core by winding the customarily employed rubber thread or by injection molding using thermoplastic elastomer (TPE);

4. forming a second intermediate layer around the first intermediate layer by winding the customarily employed rubber thread or by injection molding using thermoplastic elastomer (TPE); and

5. forming a cover layer of Surlyn around the second intermediate layer by injection molding.

Undeniably methods described above are able to produce three or four layer golf balls and widely employed. But these methods have the following drawbacks in actual operation:

1. Placing an intermediate layer between the core and the cover to form a three-layer golf ball or placing a first and a second intermediate layers between the core and the cover to form a four-layer golf ball adds to processing complexity, inconvenience and cycle time. The process of coating with a layer of thermoplastic elastomer or rubber thread in particular boosts the costs of materials and labor.

2. Each coating of an intermediate layer or a first and a second intermediate layers around the core must conform to the dimension and roundness specifications, which apparently requires additional work in processing and raises the possibility of failure as defects are prone to occur in the process.

3. The union between the core and the intermediate layer or between the first and second intermediate layer or between the second intermediate layer and the cover layer is achieved through separate processing, making the whole process more tedious, time-consuming and non-economical. Moreover, multiple processing steps are likely to produce structural deviations, such as non-uniformity in density or thickness, or the lack of concentricity for different layers, that makes the control of the golf ball flight performance more difficult.

4. The purpose of adding an intermediate layer or a first and a second intermediate layers made of rubber thread or thermoplastic elastomer is to enhance the shock absorbency of the ball given the softness of such material, thereby imparting the ball with better shot feeling and flight performance. But it is found that when the more rigid cover layer (thermoplastic resin) is formed around the softer intermediate layer or the second intermediate layer by compression molding, said softer layer is prone to deformation, thereby losing its roundness, and poor union between the deformed soft layer and the hard outer cover might occur, leading to poor yield and durability of the golf balls.

As described, the conventional methods for manufacturing three or four-layer golf balls have drawbacks in actual application and room for improvement.

### SUMMARY OF THE INVENTION

The objective of the invention herein is to provide a method for making three or four-layer golf balls characterized by blending and vulcanizing the materials for the rubber composition of the golf ball core in set proportions. The vulcanized rubber is then placed in a compression mould under 180° C. for about 120 seconds to form an integral core having a concentric construction of two or three layers with increasing hardness from inside out. Furthermore, the rigid surface layer of the core is subjected to centerless grinding and then wrapped with a cover of thermoplastic resin by injection molding to form a finished golf ball. Such method is simple, convenient, time-saving, efficient and economical, and produces high-quality golf ball and high yield. The golf ball produced thereof possesses uniform structure in each layer and a core that is not prone to deformity.

### DETAILED DESCRIPTION OF THE PREFERRED EMBODIMENT

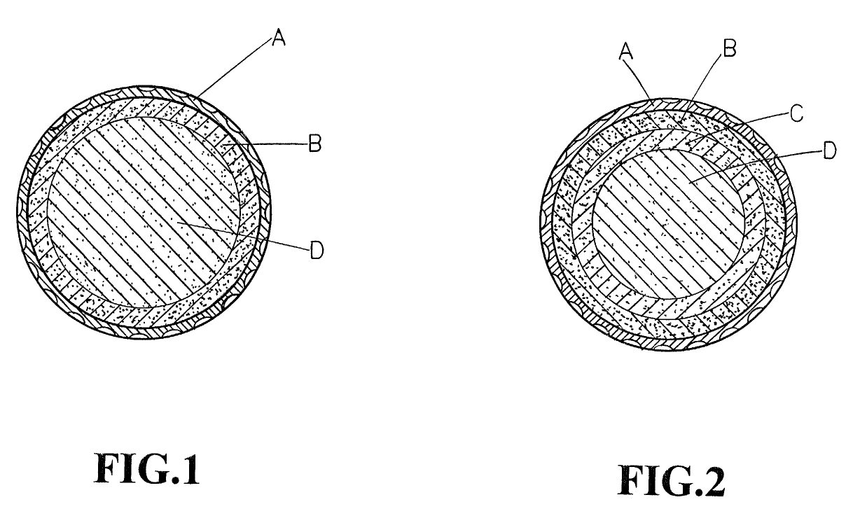

Referring to FIG. 1 and FIG. 2, the invention herein relates to a method for making three or four-layer golf ball, featuring resetting the established proportions of materials for rubber composition of the golf ball core and adding a proper amount of barytes, blending and vulcanizing these ingredients, and then placing the blend in compression mould to form the golf ball core under set temperature for a set period of time; after the core thus formed is subjected to centerless grinding to obtain the desired dimensions and roundness, a cover layer of thermoplastic resin is formed around it to produce a three or four-layer golf ball having an integral core.

Specifically the present invention entails blending the materials for rubber composition in established proportions, including 68% polybutadien rubber, 21% zinc diacrylate (ZDA), 1.8% TiO2, and 0.2% peroxide, while changing the proportion of ZnO to 2% and adding approximately 7% of barytes to the blend. After vulcanization, the blend is placed in compression mould under 180° C. for 120 seconds to form the golf ball core. Given that said barytes has good thermoinduction, high heat absorption property and superior stability, the vulcanized rubber composition may undergo 360-degree gradial and uniform endothermic reaction inwardly in the compression mould, wherein the core thus formed has a two-layer integral structure that is hard outside and soft inside under minimum contraction.

That is, after the rubber composition of this invention formed from the blending of materials in set proportions and vulcanization as described above is placed in the compression mould under 180° C. for 120 seconds, the resulting core possesses a structure that is rigid outside and soft inside; after the core is removed from the mould and left cool in the air, it will automatically form a two-layer structure as shown in FIG. 1 having a surface layer B with a wall thickness of 2.3 mm and Shore hardness of D60 and an inner layer D with a diameter of 32-34 mm and Shore hardness of D40; after the core is removed from the mold and placed in water for cooling, it will form a three-layer structure as shown in FIG. 2 having a surface layer B with a wall thickness of 2-3 mm and Shore hardness of D60, an intermediate layer C inside surface layer B with a wall thickness of 2-3 mm and Shore hardness of D30, and an inner layer D inside the intermediate layer C with a diameter of 30-32 mm and Shore hardness of D15-20.

After the said rubber composition has formed a core of two or three distinct layers with increasing hardness from inside out, the core is subjected to centerless grinding to obtain the desired dimensions and roundness. Subsequently a cover layer of Surlyn is formed around surface layer B of the core by injection molding to produce a finished golf ball. Given that surface layer B of the core is rigid, it won't be subjected to deformation when a layer of Surlyn is formed around it by injection molding. Moreover the union between the Surlyn layer and the surface layer B is strong and stable. With the absence of structural deviation, product yield and durability are enhanced.

In other words, the rubber composition disclosed in this invention, when placed in a compression mould under 180° C. for 120 seconds, may undergo 360-degree, gradual and uniform endothermic reaction inwardly on account of the properties of barytes in it (good thermoinduction, high heat absorption and superior stability) to form a core with different layer structure that is rigid outside and soft inside, and uniformly dispersed in terms of wall thickness and contraction rate around the same center. The multi-layer core construction produced by the method disclosed in this invention is of higher quality and results in higher yield than the customary methods that involve separate processing steps. With the surface layer of the core being rigid, it will unite with the Surlyn layer formed by injection molding without deformation. The three or four-layer golf ball produced thereof is thus less prone to deformation and more durable than other three or four-layer golf balls made from thermoplastic elastomer or rubber threads and Surlyn that takes several processes to complete.

As described above, the present invention entails the production of an integral two or three-layer core in one process, instead of several processes as provided in conventional methods. Thus the method disclosed in the present invention is more convenient, time-saving and results in higher yield and lower cost. The resulting product with uniformly dispersed layer structure offers better control and flight performance. Its integral core structure featuring softer inside surface and harder outside surface gives the golfers better feel and better precision control.

Moreover, if the rubber composition is removed from the compression mould after 120 seconds under 180° C. and placed in water for cooling, the inner layer D of the resulting three-layer core will have a nearly mobile colloidal structure. After cover layer of Surlyn is formed around the core by injection molding, the finished golf ball becomes exceptionally soft, giving the golfers excellent shot feeling and sense of control.

What is claimed is:

1. A method for making three or four-layer golf ball characterized by which materials for the rubber composition of the golf ball core are blended in set proportions and vulcanized, and then molded in a compression mould under the set temperature for a set period of time; wherein said rubber composition comprises 68% polybutadien rubber, 21% zinc diacrylate, 1.8% titanium dioxide, 0.2% peroxide, and features approximately 2% zinc oxide and 7% barytes; the aforesaid blended and vulcanized materials are molded in a compression mould under 180° C. for 120 seconds to form an integral core having a two or three-layer construction with increasing hardness from inside out; subsequently said core is subjected to centerless grinding to obtain the desired dimensions and roundness; finally a cover layer is formed around said core to produce a finished three or four-layer golf ball.

2. The method according to claim 1 wherein said core removed from said compression mould is cooled in the air, a construction having two layers of different hardness is produced directly, in which the surface layer has a wall thickness of 2-3 mm and Shore hardness of D60, and the inner layer has a diameter of 32-34 mm and Shore hardness of D40.

3. The method according to claim 1 wherein said core removed from said compression mould is cooled in the water, a construction having three layers of different hardness is produced directly, in which the surface layer has a wall thickness of 2-3 mm and Shore hardness of D60, the intermediate layer inside said surface layer has a wall thickness of 2-3 mm and Shore hardness of D30, and the inner layer inside said intermediate layer has a diameter of 30-32 mm and Shore hardness of D15-20.
